(19) United States
(12) Patent Application Publication
(10) Pub. No.: US 2009/0150433 A1
(43) Pub. Date: Jun. 11, 2009

(54) Method, Apparatus and Computer Program Product for Using Media Content as Awareness Cues

(75) Inventors: Jussi Severi Uusitalo, Hameenlinna (FI); Juha Arrasvuori, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/952,452

(22) Filed: Dec. 7, 2007

(51) Int. Cl. G06F 7/00; G06F 17/30

(52) U.S. Cl. 707/104.1; 707/E17.009

(57) ABSTRACT

An apparatus for enabling the use of media content for providing awareness cues may include a processor. The processor may be configured to provide, to a network device, a query regarding a particular entity, receive a content item from the network device in response to the query, the content item being determined as a result of a search by the network device for content stored in association with a current location of the particular entity, and present the received content item.

### TECHNOLOGICAL FIELD

Embodiments of the present invention relate generally to awareness service technology and, more particularly, relate to a method, apparatus and computer program product for enabling the use of media content as awareness cues.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or request made by the user (e.g., content searching, mapping or routing services, etc.). The services may be provided from a network server or other network device, or even from the mobile terminal such as, for example, a mobile telephone, a mobile television, a mobile gaming system, etc.

Due to the ubiquitous nature of mobile communication devices, people of all walks of life are now utilizing mobile terminals to communicate with other individuals or contacts and/or to share information, media and other content. Accordingly, it is increasingly common for individuals to rely heavily on mobile communication devices for enriching their lives with entertainment, socialization and even work related activities. However, when communicating with, or even observing via presence information, a friend or other contact, it may be useful or interesting if the context or surroundings of the friend or other contact may be understood. Information about the context or surroundings of others may be referred to as awareness cues or information. Awareness cues could include, for example, location, device profile information, calendar entries, devices (or people) in proximity, etc. Combinations of the information above may provide useful information for determining the context of an individual. However, in some cases, merely knowing where another person is and what that person is doing may not give a full appreciation for the person's context.

Currently, if an individual desires awareness cues with respect to a person, one way to get such information could be via text based presence information or a map location indicative of the location of the person. However, such information may not be useful to individuals that do not enjoy map reading or have map reading skills. Furthermore, such information may be considered limited in its scope and interest level. Thus, another mechanism for receiving further awareness cues may include placing a call to the person to request images or video be sent by the person to provide further awareness cues associated with the person. Such a mechanism may provide more information about the surroundings of the person being called. However, the person called may not be currently able to receive the call or to set up for sending media back to the caller. Moreover, current mechanisms for providing awareness cues may be considered laborious or even intrusive. Other mechanisms exist for sharing pictures or other media captured by one person with other friends or contacts, but the pictures and/or media captured are merely associated with the person's past experiences and therefore typically do not provide any useful awareness cues.

Accordingly, it may be desirable to provide an improved mechanism for providing awareness cues, which may overcome at least some of the disadvantages described above.

### BRIEF SUMMARY

A method, apparatus and computer program product are therefore provided to enable the use of media content such as, for example, images, sounds, video, etc., for providing awareness cues. In particular, a method, apparatus and computer program product are provided that may enable a user to access media content associated with a particular geographic location corresponding to the location of another individual. The media content may be provided, for example, from a collection of pictures or even other media that may be associated with other entities. In an exemplary embodiment, the collection of media may be maintained and provided by a service offered over a communication network. Thus, for example, if the user desires awareness cues related to a particular contact, the user may receive pictures that have been captured by other users, the service provider, or a third party and stored in association with the current location of the particular contact. As the location of the particular contact changes, the user may receive real-time changes in content or pictures based on the changes to the location of the particular contact. Accordingly, for example, the user may receive awareness cues of potentially greater interest or utility, while avoiding the laborious or intrusive activities that may be required by conventional awareness cue mechanisms.

In one exemplary embodiment, a method of enabling the use of media content for providing awareness cues is provided. The method may include providing, to a network device, a query regarding a particular entity, receiving a content item from the network device in response to the query, the content item being determined as a result of a search by the network device for content stored in association with a current location of the particular entity, and presenting the received content item.

In another exemplary embodiment, a computer program product for enabling the use of media content for providing awareness cues is provided. The computer program product includes at least one computer-readable storage medium having computer-readable program code portions stored therein. The computer-readable program code portions include first, second and third executable portions. The first executable portion is for providing, to a network device, a query regarding a particular entity. The second executable portion is for receiving a content item from the network device in response to the query, the content item being determined as a result of a search by the network device for content stored in association with a current location of the particular entity. The third executable portion is for presenting the received content item.

In another exemplary embodiment, an apparatus for enabling the use of media content for providing awareness cues is provided. The apparatus may include a processor. The processor may be configured to provide, to a network device, a query regarding a particular entity, receive a content item from the network device in response to the query, the content item being determined as a result of a search by the network device for content stored in association with a current location of the particular entity, and present the received content item.

In another exemplary embodiment, an apparatus for enabling the use of media content for providing awareness cues is provided. The apparatus includes means for providing, to a network device, a query regarding a particular entity, means for receiving a content item from the network device in response to the query, the content item being determined as a result of a search by the network device for content stored in association with a current location of the particular entity, and means for presenting the received content item.

Embodiments of the invention may provide a method, apparatus and computer program product for employment, for example, in social network or other environments. As a result, for example, mobile terminal users may enjoy an improved capability for providing or receiving awareness cues in relation to other users.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for enabling the use of media content for providing awareness cues according to an exemplary embodiment of the present invention;

FIG. 4 illustrates a block diagram of portions of a system for enabling the use of media content for providing awareness cues according to an exemplary embodiment of the present invention; and

FIG. 5 is a flowchart according to an exemplary method for enabling the use of media content for providing awareness cues according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

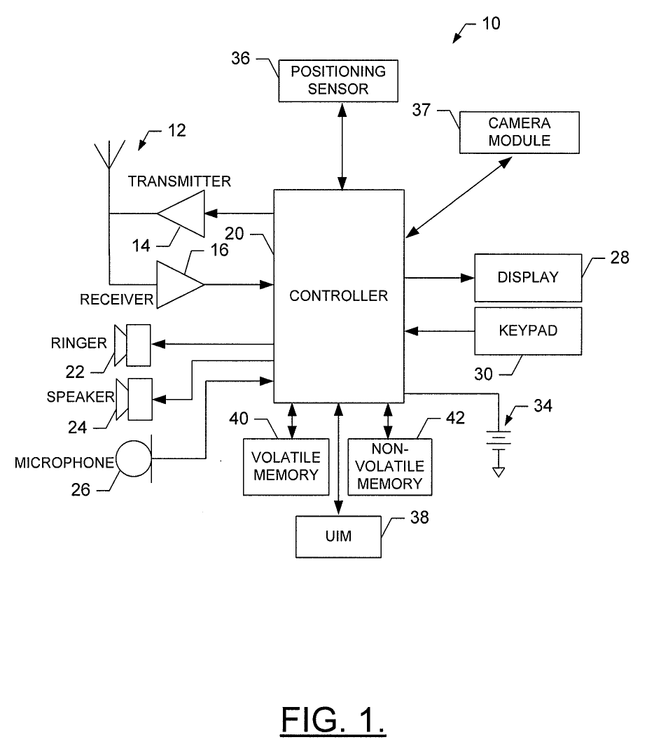

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

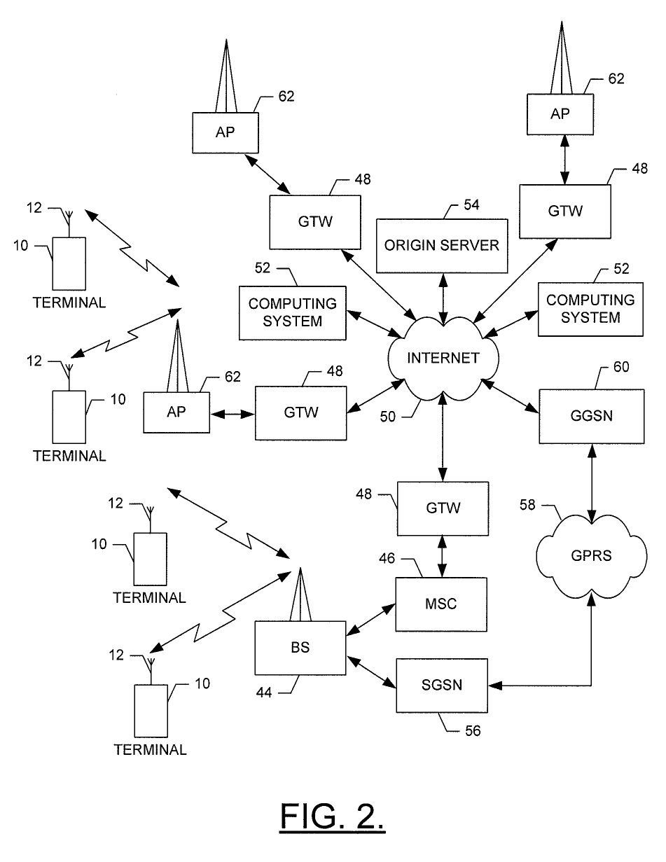

The mobile terminal 10 includes an antenna 12 (or multiple antennae) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image, or a video file from a series of captured image frames with or without accompanying audio data. As such, the camera module 37 includes all hardware, such as a lens or other optical device, and software necessary for creating a digital image, video or audio file from captured image/audio data. Alternatively, the camera module 37 may include only the hardware needed to capture an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

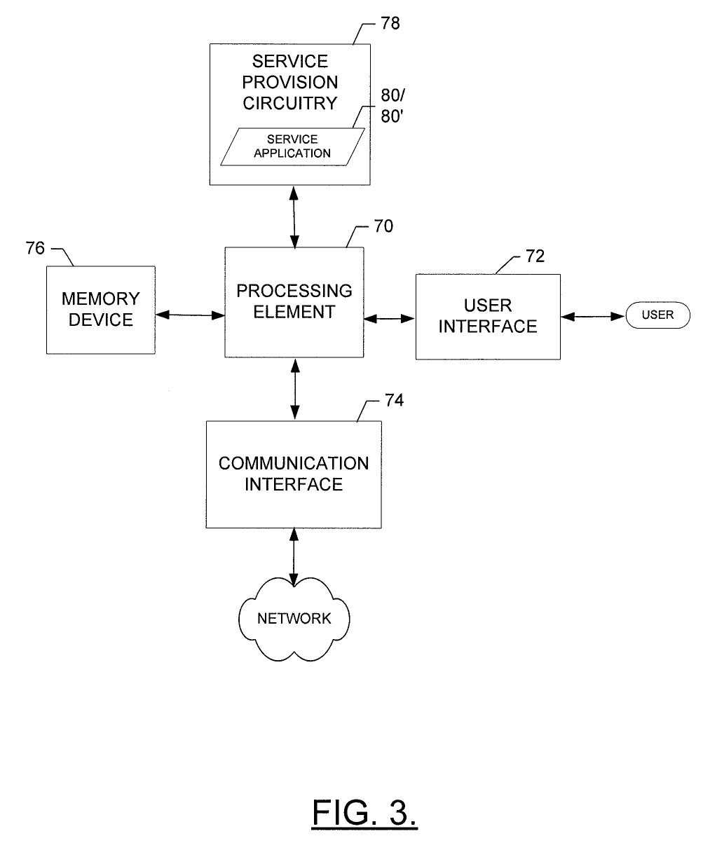

An exemplary embodiment of the invention will now be described with reference to FIG. 3, in which certain elements of an apparatus for enabling the use of media content for providing awareness cues are displayed. The apparatus of FIG. 3 may be embodied as or otherwise employed, for example, on the mobile terminal 10 of FIG. 1 or a network device such as a server of FIG. 2. However, it should be noted that the system of FIG. 3, may also be employed on a variety of other devices, both mobile and fixed, and therefore, the present invention should not be limited to application on devices such as mobile terminals and/or servers. It should also be noted that while FIG. 3 illustrates one example of a configuration of an apparatus for enabling a user to access media content for providing awareness cues, numerous other configurations may also be used to implement embodiments of the present invention.

Referring now to FIG. 3, an apparatus for enabling the use of media content for providing awareness cues is provided. The apparatus may include or otherwise be in communication with a processing element 70 (e.g., controller 20), a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be one of a plurality of databases that store information and/or media content, for example, in association with a particular location.

The processing element 70 may be embodied in a number of different ways. For example, the processing element 70 may be embodied as a processor, a coprocessor, a controller or various other processing means or devices including integrated circuits such as, for example, an ASIC (application specific integrated circuit), a field programmable gate array (FPGA), or the like. In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network.

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processing element 70 may be embodied as or otherwise control service provision circuitry 78. In this regard, for example, the service provision circuitry 78 may include structure for executing a service application 80/80′. The service application 80/80′ may be an application including instructions for execution of various functions in association with embodiments of the present invention. In an exemplary embodiment, the service application 80 may include or otherwise communicate with applications, devices and/or circuitry for receiving media content (e.g., pictures, video, audio, etc.). Meanwhile, the service application 80′ may include or otherwise communicate with applications, devices and/or circuitry for receiving information (e.g., from a location service and/or a content search service) in order to provide media content to the service application 80. The location service may enable the determination of location of a particular device and/or may further include routing services and/or directory or look-up services related to the location (e.g., business, venue, party or event location, address, site or other entity related to a particular geographic location) of the particular device. As such, according to an exemplary embodiment, the processing element 70 (for example, via the service provision circuitry 78) may be configured to enable a user to access media content associated with the current or real-time location of a particular individual as will be described in greater detail below.

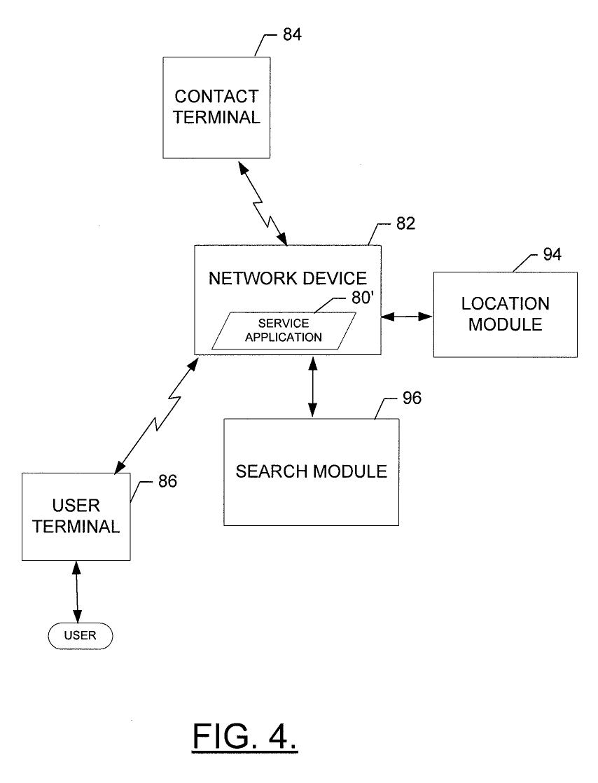

FIG. 4 illustrates an embodiment of the present invention in which certain elements of a system for enabling the use of media content for providing awareness cues are displayed. The system of FIG. 4 may be employed in connection with the mobile terminal 10 of FIG. 1 and/or the network illustrated in reference to FIG. 2. However, although FIG. 4 illustrates an embodiment of the present invention being practiced in connection with a network device 82 (e.g., a server) that may assist in the coordination of functionality associated with practicing embodiments of the invention in combination with other devices, it should be noted that the system of FIG. 4 may also be employed on a variety of other devices, both mobile and fixed, and therefore, the present invention should not be limited to application on devices such as servers or in combination with the specific devices illustrated in FIG. 4. As such, it should be appreciated that while FIG. 4 illustrates one example of a configuration of a system for enabling the use of media content for providing awareness cues, numerous other configurations may also be used to implement embodiments of the present invention. As such, the devices or elements described below may not be mandatory and thus some may be omitted in certain embodiments. Moreover, embodiments of the present invention need not be practiced at a single device, but rather combinations of devices may collaborate to perform embodiments of the present invention.

Referring now to FIG. 4, a system for enabling the use of media content for providing awareness cues is provided. The system may include the network device 82, which may be in communication with a contact terminal 84 and a user terminal 86. In an exemplary embodiment, the user terminal 86 and the contact terminal 84 may each be an example of the mobile terminal 10 of FIG. 1, the apparatus of FIG. 3 (e.g., utilizing the service application 80), or a similar device. Meanwhile, the network device 82 may be an example of a device similar to the apparatus of FIG. 3 (e.g., utilizing the service application 80′). However, in general terms, the network device 82 may be any means or device embodied in hardware, software or a combination of hardware and software that is configured to perform the corresponding functions of the network device 82 as described in greater detail below. In particular the network device 82 may include or have access to memory space for data storage such as media content items. In an exemplary embodiment, the network device 82 may store (or have access to a storage location including) media content such as pictured uploaded to the network device 82 by various subscribers to a service associated with the service application 80′. Thus, for example, pictures and other media content may be stored by the network device 82 and, in particular, such pictures and other media content may be stored in association with at least information indicative of the location of the capture or creation of the medic content (e.g., as indicated by metadata associated with the media content).

In an exemplary embodiment, a user of the contact terminal 84 may be an entity or individual that may be in a contact list or phonebook of the user terminal 86. However, the contact terminal 84 need not necessarily be in a contact list or phonebook of the user terminal 86, but instead may be identified by the user of the user terminal 86 in another way. For example, if both the user terminal 86 and the contact terminal 84 are subscribers to a particular service hosted by the network device 82, the network device 82 may provide a listing of fellow subscribers (and/or fellow community members) that may be selected in connection with practicing embodiments of the present invention. The contact terminal 84 may be assumed to be at or proximate to a particular geographic location that is remote from the location of the user of the user terminal 86. Moreover, the contact terminal 84 may be, for example, at a location for which media content was previously created, captured, produced and/or stored in association therewith. In particular, embodiments of the present invention may provide for the storage of one or more media content items stored in association with a corresponding one or more locations (e.g., by or at a location accessible to the network device 82) so that the particular media content stored in association with the current location of the contact terminal 84 may be identified. Accordingly, embodiments of the present invention may enable the user of the user terminal 86 to access media content associated with the current location of the contact terminal 84 via the network device 82.

In this regard, for example, the network device 82 (e.g., via the service application 80′) may receive a query from the user terminal 86 with respect to a particular individual (e.g., a contact in the contact list of the user terminal 86) associated with the contact terminal 84. The query may include, for example, a location query and a media content query to trigger a corresponding location determination and media content search, respectively, based on the location of the contact terminal 84. However, in some embodiments, location and media content information may be retrieved with respect to the contact terminal 84 in response to a single query from the user terminal 86 identifying the contact terminal 84. Accordingly, for example, after selection of the particular individual (or selection of the contact terminal 84 itself), an identity of the individual and/or the contact terminal 84 may be communicated to or determined by the network device 82. The network device 82 may then determine the location of the contact terminal 84 and/or determine whether media content associated with the location of the contact terminal 84 is available. The media content may then be served to the user terminal 86 in response to the query.

In an exemplary embodiment, the network device 82 may identify most recently stored media content associated with the location of the contact terminal 84 for service to the user terminal 86. For example, pictures captured by third parties, any other users of the service, or even by the contact terminal 84, which have recently been stored and are associated with the current location of the contact terminal 84, may be identified and one or more of the most recent pictures may be served to the user terminal 86. In this regard, the network device 82 may access metadata associated with each media content item to determine, for example, the time, date, location, or numerous other characteristic relating to the context or conditions relating to the capturing or creation of each corresponding media content item.

Thus, in an exemplary embodiment, media content may not just be associated with a particular location, but may be further associated with a particular time, date, event, and/or weather condition. Accordingly, for example, media content associated with seasonal, weather, time, or other like conditions may be served to the user terminal 86 based on the corresponding current conditions at the location of the contact terminal 84. Thus, as a specific example, if it is a snowy winter morning at the location of the contact terminal 84, in response to the query from the user terminal 86, the network device 82 may determine the location and/or conditions at the location of the contact terminal 84 and identify media content such as pictures stored in association with snow, winter and/or morning at the location of the contact terminal 84. Similarly, if the location of the contact terminal 84 is a particular venue or arena that hosts various sporting events and/or social events, etc., metadata associated with various content items may be used to differentiate between different events so that media content associated with a current, most recent, or next event scheduled in association with the venue or arena may be displayed in response to the query.

In an exemplary embodiment, the network device 82 may include or be in communication with applications and/or circuitry for providing a location service (e.g., location module 94) and/or a content search service (e.g., search module 96). However, it should be noted that code, circuitry and/or instructions associated with the location module 94 and/or the search module 96 need not necessarily be modular. The location module 94 and/or the search module 96 may each be any means or device embodied in hardware, software or a combination of hardware and software that is configured to perform the corresponding functions of the location module 94 and/or the search module 96, respectively, as described below.

In this regard, the location module 94 may be configured to determine a current location of an identified device. In particular, the location module 94 may, in response to the identification of a particular device as indicated in the query from the user terminal 86, determine the current location of the particular device (e.g., the contact terminal 84). The determined location of the contact terminal 84 may then be used by the network device 82 (e.g., via that search module 96) as criteria for locating content items (e.g., pictures) associated with the determined location. In some embodiments, the determined location of the contact terminal 84 may not be communicated to the user terminal 86, but instead only media content associated with the determined location may be communicated to the user terminal. However, in some alternative embodiments, the location module 94 may be configured to communicate the determined location of the contact terminal 84 to the user terminal 86. In this regard, for example, the communication with regard to the determined location may be made in a text form (e.g., providing a street address, point of interest name, etc.) or in a visual format such as by an indication on a map. As such, the location module 94 may be further configured to display a map of a particular area corresponding to the determined location. Moreover, the map displayed may include landmarks, roads, buildings, service points or numerous other geographical features. The location module 94 may be further configured to include routing services. For example, the location module 94 may be configured to determine one or more candidate routes between a current or starting location and a destination based on any known route determination methods. The location module 94 may incorporate into the map display various ones of the geographical features and other supplemental information about a particular location. Furthermore, the location module 94 may display an icon or another identifier that is indicative of the current location of the contact terminal 84 on the map display. In some embodiments, the map display may further include icons, avatars or other representations of other entities or individuals (e.g., other subscribers to the service), which may be in proximity to the contact terminal 84 and which may be visible on the map display. Thus, for example, the contact terminal 84 may be indicated with a particular icon or avatar and other individuals may be indicated with other distinctive icons and/or avatars.

In one embodiment, the icon or avatar associated with each individual may be coded or designated in some way to indicate whether there are media content items that are stored in association with the corresponding location of the icon or avatar. Furthermore, in some embodiments, the map display may be provided to the user terminal 86 in a manner that permits selection of the coded or designated icon/avatar in order to enable access to the corresponding content items associated therewith. Thus, for example, if multiple contacts happen to be displayed on a particular map display, the user terminal 86 may switch between viewing content items associated with contacts in various different locations by selection of the corresponding coded or designated icon/avatar. In some embodiments, the map display may be provided to the user terminal 86 and content items may be accessed therefrom in a manner similar to that described above. However, in an alternative embodiment, the map display may be provided simultaneously with a display of content items either as an overlay or in a split screen format.

In an exemplary embodiment, the search module 96 may include a search engine configured to receive a search term identification and search various accessible sources (e.g., databases such as may be included in the memory device 76 or may be otherwise accessible to the network device 82) for information associated with the search term identification. The search term may be, for example, a location associated with the contact terminal 84 as determined by the location module 94 and thereafter provided to the search module 96. In response to a search associated with the determined location of the contact terminal 84, the search module 96 may be configured to identify and/or provide content items associated with the determined location to the network device 82. The network device 82 may then serve one or more of the content items associated with the determined location to the user terminal 86.

As indicated above, the content items that may be served to the user terminal 86 need not necessarily be served in connection with a map display. In this regard, for example, although the content items could be served in addition to the map display, the content items could also be served by themselves. In either case, each content item could be served, for example, as a selectable thumbnail, as a full or partial screen picture, as a slide in a slideshow, etc. The user terminal 86 may enable navigation between content items via the user interface 72. In an exemplary embodiment, if a panoramic view (e.g., a 360 degree picture) is available (or if a panoramic view may be generated from a collection of related images) a portion of the panoramic view may be displayed and the user terminal 86 may enable navigation (e.g., via a scrolling function or key manipulation) to various parts of the panoramic view. Furthermore, in one implementation, heading information associated with the user of the contact terminal 84 may be used to influence which content items and/or images may be presented to the user terminal 86. Alternatively, the heading information may be utilized to dictate an ordering of content items that may be associated with a particular location. In this regard, for example, heading information may be provided to the user terminal 86 from any available mechanism (e.g., from GPS data, location trail information, compass heading, a motion vector determinable from locations associated with previously served media content items, etc.). Thus, for example, as the contact terminal 84 approaches a particular location, content items corresponding to the particular location may be presented to the user terminal 86. The presented content items may correlate to the first person view that an individual associated with the contact terminal 86 would have as the particular location is approached, thereby updating the content items that are presented to the user terminal 86.

In an exemplary embodiment, updating of content items (e.g., the presentation of new images) presented to the user terminal 86 may take place at certain intervals which may be measured in terms of temporal or spatial distance. For example, updates could occur at a given time interval or distance interval. Moreover, the time and/or distance interval could be variable on the basis of user preference, time, speed of travel of the contact terminal 86, location of the contact terminal 86, the number of content items associated with the location (i.e., image density), etc. User preferences (e.g., as indicated in a user profile) could also dictate rules regarding what content items are to be displayed (e.g., on the basis of location, time, etc., or having a given ordering) so that the user of the user terminal 86 may tailor the display of content items to the user's liking. User preferences of the user of the contact terminal 84 may also impact display characteristics. For example, the user of the contact terminal 84 may provide rules dictating whether and/or under what conditions content items corresponding to the location of the contact terminal 84 may be released to others. In this regard, the contact terminal 84 may predefine particular times, locations, etc., at which location information and/or content items can or cannot be provided to others. Alternatively or additionally, the contact terminal 84 may specify specific individuals to which corresponding specific rules regarding disclosure of location/content items may be made. For example, certain circles of friends or family members may have unlimited access to information regarding disclosure of location/content items, while other individuals may have access that is limited based on time, location, etc. In one embodiment, the contact terminal 84 may receive an indication that a query has been received regarding the contact terminal 84 each time such a query is issued (or if a corresponding user preference is selected). Thus, the user of the contact terminal 84 may, for example, allow or disallow the release of location information and/or content items associated with the location of the contact terminal 84 for each query that is received.

In an exemplary embodiment, the user terminal 86 may store (either temporarily or permanently) images or other content items that are received in connection with a query or series of queries regarding the contact terminal 84. Thus, for example, the user may review the track of the contact terminal 84 based on previously served content items. The previously served content items could be viewed, for example, in a slideshow or other format.

According to one exemplary embodiment, optional features may be presented in addition to content items such as images. For example, in one embodiment, avatars, icons or nicknames of other individuals that may be proximate to the contact terminal 84 and known to the user of the user terminal 86 may be displayed on or in association with a content item. For example, if an image of a particular location or venue is displayed based on the location of the contact terminal 84 and other individuals known to the user of the user terminal 84 are determined to be at or near the particular location or venue. An indicator of the presence of the other individuals (either individually or collectively) may be presented via a display of the user terminal 84. In one embodiment, the service application 80/80′ may be configured to analyze a particular image to determine whether a feature such as a door may be identified. Thus, under certain circumstances, if a door can be determined with regard to a particular location and the location information (e.g., motion vector) of the contact terminal 84 indicates a likelihood that the user of the contact terminal 84 passed through the door, the door may be highlighted on the display of the user terminal 86. Shape algorithms may be used to determine features such as the door. Additionally, certain images may be stored with metadata information indicative of the orientation of the image with respect to the coordinates of the associated location in order to enhance the capability of determining motion of the contact terminal 84 with respect to certain features at the location that may be determinable from images associated therewith.

Another optional feature that may be associated with embodiments of the present invention relates to providing additional descriptions that may accompany the presentation of content items. Thus, for example, the user of the contact terminal 86 may provide text or other input that may be associated with describing the current location of the contact terminal 86. The descriptions provided by the contact terminal 86 may be uploaded to the service application 80′ and may be provided to the user terminal 84 in response to the query either with or independent of the content items that are provided in connection with the location of the contact terminal 84. Thus, for example, if the user of the user terminal 86 plays a slideshow corresponding to the travels or movement of the contact terminal 84, the user of the user terminal may appreciate the changes in emotion that are experienced by the user of the contact terminal 84 during the journey. In an exemplary embodiment, the emotional changes could be expressed, for example, as changes to the facial expression of an avatar.

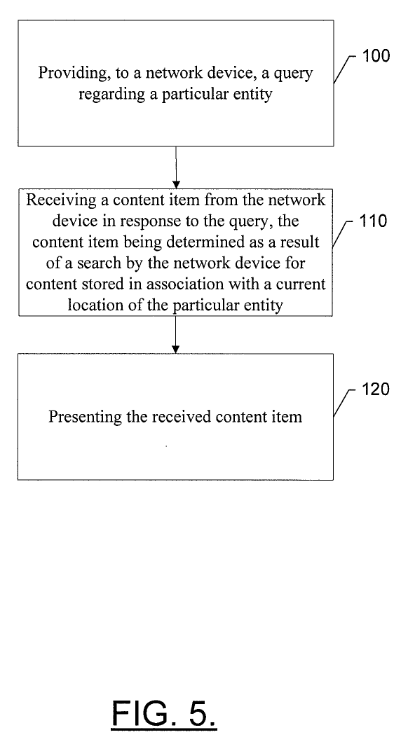

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a built-in processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling the use of media content as awareness cues as illustrated, for example, in FIG. 5 may include providing, to a network device, a query regarding a particular entity at operation 100. At operation 110, a content item may be received from the network device in response to the query. The content item may be determined as a result of a search by the network device for content stored in association with a current location of the particular entity. The received content item may then be presented at operation 120. The presentation could be via displaying the content item and/or via rendering audio corresponding to the content item.

In an exemplary embodiment, the method may include additional optional operations each of which may be accomplished by itself or in combination with other options mentioned below as additional operations to the general method described above and illustrated in FIG. 5. As such, each of the operations discussed below could be an additional operation added in sequence to the operations above. For example, the method may include displaying a map indicating a location of the particular entity. As an alternative, the method may include receiving information provided to the network device by the particular entity. The information may be indicative of feelings of the particular entity associated with the current location of the particular entity. As yet another alternative, the method may include providing additional content items at a predetermined interval. The content items may be stored as a record of movement of the particular entity. In an exemplary embodiment, the method may further include determining a feature (e.g., a door) within the content item and, based on a direction of movement of the particular entity, determining an action of the particular entity with respect to the determined feature (e.g., passage through the door). A highlighting of the feature may be provided as an indication of the determined action of the particular entity.

In an exemplary embodiment, displaying the received content item may include displaying a representation of at least one other entity proximate to the location of the particular entity. Additionally or alternatively, receiving the content item may include receiving a particular content item sharing at least one characteristic other than location in common with current conditions at the current location of the particular entity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing, to a network device, a query regarding a particular entity;
receiving a content item from the network device in response to the query, the content item being determined as a result of a search by the network device for content stored in association with a current location of the particular entity; and
presenting the received content item.

2. A method according to claim 1, further comprising displaying a map indicating a location of the particular entity.

3. A method according to claim 1, further comprising receiving information provided to the network device by the particular entity, the information being indicative of feelings of the particular entity associated with the current location of the particular entity.

4. A method according to claim 1, further comprising providing additional content items at a predetermined interval.

5. A method according to claim 4, further comprising storing the content item and the additional content items as a record of movement of the particular entity.

6. A method according to claim 1, further comprising determining a feature within the content item and, based on a direction of movement of the particular entity, determining an action of the particular entity with respect to the determined feature.

7. A method according to claim 1, wherein presenting the received content item further comprises displaying a representation of at least one other entity proximate to the location of the particular entity.

8. A method according to claim 1, wherein receiving the content item further comprises receiving a particular content item sharing at least one characteristic other than location in common with current conditions at the current location of the particular entity.

9. A computer program product comprising at least one computer-readable storage medium having computer-readable program code portions stored therein, the computer-readable program code portions comprising:
a first executable portion for providing, to a network device, a query regarding a particular entity;
a second executable portion for receiving a content item from the network device in response to the query, the content item being determined as a result of a search by the network device for content stored in association with a current location of the particular entity; and
a third executable portion for presenting the received content item.

10. A computer program product according to claim 9, further comprising a fourth executable portion for displaying a map indicating a location of the particular entity.

11. A computer program product according to claim 9, further comprising a fourth executable portion for receiving information provided to the network device by the particular entity, the information being indicative of feelings of the particular entity associated with the current location of the particular entity.

12. A computer program product according to claim 9, further comprising a fourth executable portion for providing additional content items at a predetermined interval.

13. A computer program product according to claim 12, further comprising a fifth executable portion for storing the content item and the additional content items as a record of movement of the particular entity.

14. A computer program product according to claim 9, further comprising a fourth executable portion for determining a feature within the content item and, based on a direction of movement of the particular entity, determining an action of the particular entity with respect to the determined feature.

15. A computer program product according to claim 9, wherein the third executable portion includes instructions for displaying a representation of at least one other entity proximate to the location of the particular entity.

16. A computer program product according to claim 9, wherein the second executable portion includes instructions for receiving a particular content item sharing at least one characteristic other than location in common with current conditions at the current location of the particular entity.

17. An apparatus comprising a processor configured to:
provide, to a network device, a query regarding a particular entity;
receive a content item from the network device in response to the query, the content item being determined as a result of a search by the network device for content stored in association with a current location of the particular entity; and
present the received content item.

18. An apparatus according to claim 17, wherein the processor is further configured to display a map indicating a location of the particular entity.

19. An apparatus according to claim 17, wherein the processor is further configured to receive information provided to the network device by the particular entity, the information being indicative of feelings of the particular entity associated with the current location of the particular entity.

20. An apparatus according to claim 17, wherein the processor is further configured to provide additional content items at a predetermined interval.

21. An apparatus according to claim 20, wherein the processor is further configured to store the content item and the additional content items as a record of movement of the particular entity.

22. An apparatus according to claim 17, wherein the processor is further configured to determine a feature within the content item and, based on a direction of movement of the particular entity, determine an action of the particular entity with respect to the determined feature.

23. An apparatus according to claim 17, wherein the processor is further configured to display a representation of at least one other entity proximate to the location of the particular entity.

24. An apparatus according to claim 17, wherein the processor is further configured to receive a particular content item sharing at least one characteristic other than location in common with current conditions at the current location of the particular entity.

25. An apparatus comprising:
means for providing, to a network device, a query regarding a particular entity;
means for receiving a content item from the network device in response to the query, the content item being determined as a result of a search by the network device for content stored in association with a current location of the particular entity; and
means for presenting the received content item.
